(19) United States
(12) Patent Application Publication
(10) Pub. No.: US 2006/0122821 A1
(43) Pub. Date: Jun. 8, 2006

(54) Method for detecting and processing sensitive non-privileged processor instructions in a virtual machine computer system

(75) Inventor: Christian Hildner, Nurnberg (DE)

Correspondence Address: BROWDY AND NEIMARK, P.L.L.C.;624 NINTH STREET, NW, SUITE 300, WASHINGTON, DC, 20001-5303, US

(73) Assignee: HOB GmbH & Co. KG, Cadolzburg (DE)

(21) Appl. No.: 11/004,813

(22) Filed: Dec. 7, 2004

(51) Int. Cl. G06F 9/455

(52) U.S. Cl. 703/26

(57) ABSTRACT

A method for detecting and processing sensitive non-privileged processor instructions in a virtual machine computer system running computer guest system processes in a virtualized manner on a central processing means checks the state of the virtual central processing means to be critical or not. In case the state is not critical normal virtual machine operation is continued. In case the state of the virtual central processing means is critical all instructions and thus each sensitive instruction can be emulated. To improve the performance in the critical state of the virtual CPU the instructions can be analyzed by single-stepping or pre-analyzing and setting a breakpoint before a sensitive instruction. This is followed by running the process up to the breakpoint directly and emulating the following sensitive instruction.

### BACKGROUND OF THE INVENTION

1. Field of the Invention

The invention relates to a method for detecting and processing sensitive non-privileged processor instructions in a virtual machine computer system running computer guest system processes in a virtualized manner on a central processing means.

2. Background Art

In the field of virtual machine computer systems the virtual machine monitor controls and handles concurrently running guest processes. In this connection commonly a subset of the complete instruction set of a CPU architecture is to be emulated. The instructions of said subset are called “sensitive instructions”. Within the entirety of the instructions of a certain processor said sensitive instructions are potentially disruptive of the virtual machine monitor or host operating system within a virtualized environment.

Another type of instructions is commonly relevant as concerns the question whether or not a processor is virtualizable. These are the so-called “privileged instructions” which are machine code instructions that may only be executed when the processor is running in the supervisor mode. Privileged instructions include operations such as input/output and memory management. As a general rule a processor is virtualizable, if all sensitive instructions are privileged, because the execution of a privileged instruction creates an exception if the processor does not run in the highest privileged mode, which is used by common virtual machine monitors to detect these instructions.

One common problem designing virtual machines, however, lies in the fact that many CPU architectures contain sensitive instructions which are not privileged. This fact makes them difficult to detect what is especially critical if a certain CPU state is emulated for the guest and the execution of the instruction depends on the state of the virtual central processing means.

An example for such a critical instruction is the so-called “cover stack frame” instruction (in the following abbreviated as “cover instruction”) of the Intel® Itanium® IA 64 architecture. Said cover instruction of the Itanium® architecture is in fact sensitive, non-privileged and critical to the CPU state, respectively. Reference is made to the “Intel® IA 64 Architecture Software Developer's Manual”, volume 3: IA-64 instruction reference (rev 1.1 July 2000), page 2-34. This cover instruction modifies the registered stack frame and writes a control register depending on the state of the processor status. The latter is represented by the so-called “interrupt collection” flag (=PSR.ic) which takes the value “0” if interruption collection is disabled and the value “1” if interruption collection is enabled.

Since the virtual machine always has to run guest processes with interrupt collection enabled (PSR.ic=1), the cover instruction would not write the control register, so information about the size of the register stack frame would get lost.

### SUMMARY OF THE INVENTION

Starting from the aforementioned problems of the prior art the object of the invention is to provide a method for detecting and processing sensitive non-privileged processor instructions in a virtual machine computer system running computer guest system processes in a virtualized manner on a central processing means, by which method a save and uncritical processing of such sensitive non-privileged processor instructions in a virtualized environment is ensured.

This object is achieved by a method for detecting and processing sensitive non-privileged processor instructions in a virtual machine computer system comprising
switching between two virtual machine operation modes wherein a first mode is a classic mode, in which only privileged instructions are intercepted, and a second mode is a restricted operation mode, and

using the restricted mode being used according to a specific critical state of the virtualized processor, wherein in the restricted mode sensitive non-privileged instructions are detected.

In a preferred embodiment of the invention the restricted mode uses emulation of instructions including the emulation of sensitive instructions.

In another preferred embodiment of the invention said method for detecting and processing sensitive non-privileged processor instructions in a virtual machine computer system comprises following method steps:
A) checking the state of the virtual central processing means to be critical or not,
B1) in case the state is not critical continuing normal virtual machine operation,
B2) in case the state is critical emulating the instruction,
C) checking the state of the virtual processing means to be still critical or not,
D1) in case the state is still critical returning to one of step A) and B2),

D2) in case the state is not critical continuing normal virtual machine operation with step A).

Aforesaid method and preferred embodiments represent the straight forward technique for handling sensitive, non-privileged instructions as said instructions are not detected per se, but all instructions are emulated when the virtual central processing unit is in its critical state. Doing so any such sensitive non-privileged instructions are also emulated rather than executed by the central processing unit directly. Inasmuch the overall behavior of the central processing unit including the managing of sensitive non-privileged instructions can easily be virtualized by emulation. Said emulation of an instruction code is finalized when the virtual central processing means leaves the critical state. From this time on normal virtual machine operation continues until the virtual central processing means enters the critical state again.

In another preferred embodiment of the invention the restricted mode uses single stepping to intercept before the execution of each instruction to allow the detection and emulation of sensitive non-privileged instructions. In more detail said method preferably comprises following method steps:
A) checking the state of the virtual central processing means to be critical or not,
B1) in case the state is not critical continuing normal virtual machine operation,
B2) in case the state is critical
   B2.1) enabling single stepping processor mode and
   B2.2) checking whether or not a following instruction is sensitive,
   B2.3.1) in case the following instruction is sensitive emulating said instruction, or
   B2.3.2) in case the following instruction is not sensitive executing the instruction,
C) checking the state of the virtual processing means to be still critical or not,
D1) in case the state is still critical return to step B2.2),
D2) in case the state is not critical any more disabling single stepping mode and
E) continuing normal virtual machine operation with step A).

This preferred embodiment of the invention makes use of the fact that the problem of sensitive but non-privileged instructions as a rule only appears in a certain critical state of the virtual central processing means, e.g. whether or not the virtual central processing system is in the interruption collection enabled (=“interrupt enabled”) state or the interruption collection disabled (=“interrupt disabled”) state. The interrupt disabled state is the critical state in which e.g. the so-called cover instruction is sensitive but non-privileged. To filter out such problematic instruction it is only necessary to switch to single-stepping in case the virtual central processing unit is in said critical state. Otherwise single-stepping a complete routine of a plurality of instructions would lead to a high performance loss. To bring such overhead down to a negligible level single-stepping is only used for guest instruction sequences which run in a critical CPU state to detect above-mentioned non-privileged sensitive instructions.

According to a further preferred embodiment of the invention the restricted mode analyzes code sequences and uses instruction breakpoints to intercept after execution of that code sequence. Preferably the code sequence is analyzed for an occurrence of sensitive non-privileged instructions and branch instructions.

Finally in a further preferred embodiment of the invention above mentioned object is achieved by a novel method for detecting and processing sensitive non-privileged processor instructions in a virtual machine computer system comprising following method steps:
A) checking the state of the virtual central processing means to be critical or not,
B1) in case the state is not critical continuing normal virtual machine operation,
B2) in case the state is critical analysing each following instruction of an instruction sequence whether or not the instruction is one of a branch instruction or sensitive instruction,
B3.1) in case that no branch instruction or sensitive instruction is detected continuing normal machine operation,
B3.2.1) in case that one of the branch instruction or sensitive instruction is detected setting a break point in front of said instruction,
B3.2.2) executing the instructions up to the breakpoint,
B3.2.3) starting next sequence at a target of said branch instruction or emulating said sensitive instruction, and
C) continuing normal machine operation with step A).

This method again is based on a first distinguishing fact which is the state of the virtual central processing means being critical or not. Now in the critical state a code of instructions is analyzed to find non-privileged sensitive instructions or branch instructions. By setting a breakpoint in front of said instruction the overall code sequence is foreshortened to a sub-sequence which is executed until reaching the breakpoint. In case the breakpoint is followed by a branch instruction, the latter is emulated and the next sub-sequence is analyzed starting from the branch target if the branch is taken. In case the instruction following the breakpoint is a non-privileged, sensitive instruction said instruction is emulated and the next sub-sequence is analyzed starting after that instruction.

In a preferred embodiment of aforementioned method including breakpoint setting, if non-branch instructions or non-sensitive instructions are selected, analyzing of memory modifying instructions takes place. Inasmuch each following instruction of a sequence is checked whether or not it is a store instruction and a breakpoint is set after that instruction. Afterwards the sub-sequence of instructions up to the breakpoint is executed. This breakpoint ensures that an analysis of following instruction sequences accesses the currently relevant set of instructions, which cannot be changed by a store instruction in an undiscovered manner. By doing so so-called “self modifying code” cannot disturb the function of the virtual machine monitor by dynamically replacing one instruction by a sensitive non-privileged instruction.

Since the detection of branch instruction is necessary to prevent code sequences (after a branch) to be wrongly analyzed without actually being executed because of that branch the detection of the branch instruction can be alternatively done by the so-called “taken branch” trap that intercepts on each branch of the program flow. Conditional branches that are not taken would indeed not disturb the function since the program flow continues with the instruction following the branch. After occurrence of the “taken branch” trap however the sequence is to be started from new at the location of the branch target.

Again the overhead of the code analyzing and the according performance loss can be minimized as only these portions of a code running with a critical CPU state are analyzed.

Further features, details and advantages of the invention are disclosed in the following description in which embodiments of the method for detecting and processing sensitive non-privileged processor instructions according to the invention are described in more detail with reference to the accompanying drawings.

### BRIEF DESCRIPTION OF THE DRAWINGS

FIG. 1 is a flow chart of a method for detecting and processing sensitive non-privileged processor instructions in a first embodiment,

FIG. 2 is a time diagram reflecting a guest process virtualized on a virtual machine by the method depicted in FIG. 1,

FIG. 3 is a flow chart of a method for detecting and processing sensitive non-privileged processor instructions in a second embodiment,

FIG. 4 is a time diagram reflecting a guest process virtualized on a virtual machine by the method depicted in FIG. 3,

FIG. 5 is a flow chart of a method for detecting and processing sensitive non-privileged processor instructions in a third embodiment, and

FIG. 6 is a time diagram reflecting a guest process virtualized on a virtual machine by the method depicted in FIG. 5.

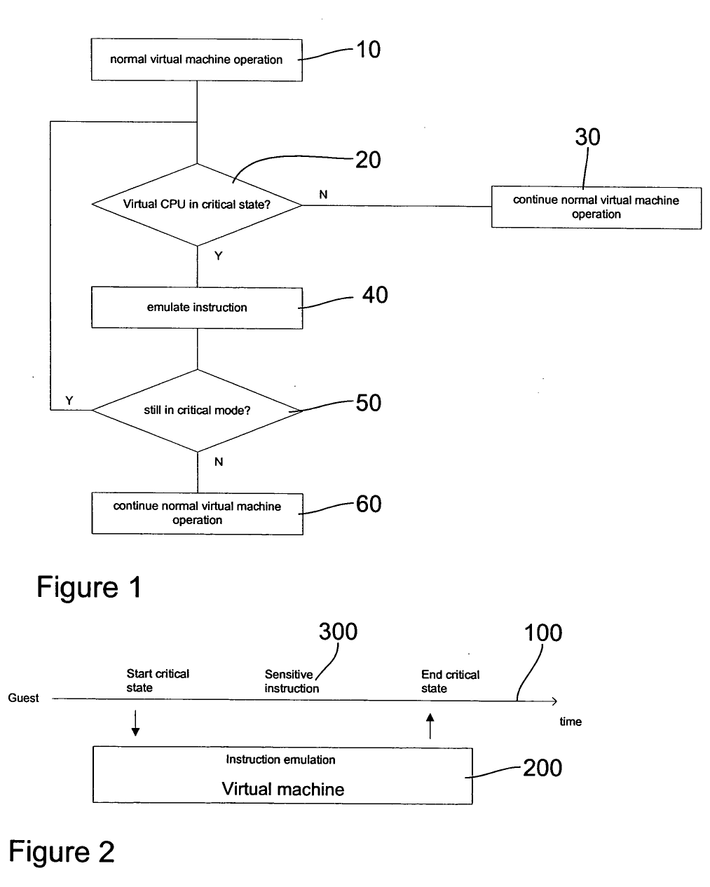

Turning to FIG. 1 step 10 denotes normal virtual machine operation, in which in step 20 the state of the virtual central processing means is checked to be critical or not. A critical state as concerns e.g. the cover instruction is the state of PSR.ic (=interrupt collection flag). If this is disabled the cover instruction is sensitive, but non-privileged what needs special managing of the process. In case the state is not critical—branch N after step 20 of FIG. 1—normal virtual machine operation is continued in step 30, what in fact means returning to step 10 and starting the check step 20 again.

In case the state of the virtual CPU is critical—branch Y after step 20—following instruction is emulated (step 40) to ensure that each sensitive, non-privileged instruction is emulated. This step, however, does not take care whether or not it is really necessary to emulate the instruction, i.e. even non-sensitive and/or privileged instructions are unnecessarily emulated.

After that step 40 the state of the virtual CPU is again checked whether it is still in a critical mode—step 50—and the checking of the critical state and emulating each instruction is continued—branch Y after step 50—until the virtual CPU state is found to be non-critical. Then the process via branch N after step 50 continues with normal virtual operation (step 60). This again means that the process continues with the check of the virtual CPU (step 20).

In FIG. 2 a guest system process is symbolized by the time bar 100 and a host virtual machine by the reference numeral 200. As can be seen the guest process 100 is handled without instruction emulation by the virtual machine until the critical state starts what is checked by step 20 of FIG. 1. The process changes to instruction emulation on the virtual machine 200 until the critical state is found to be terminated. Any sensitive instruction within the guest process—one of it is denoted in FIG. 2 by the reference numeral 300—is “automatically” emulated and thus handled properly.

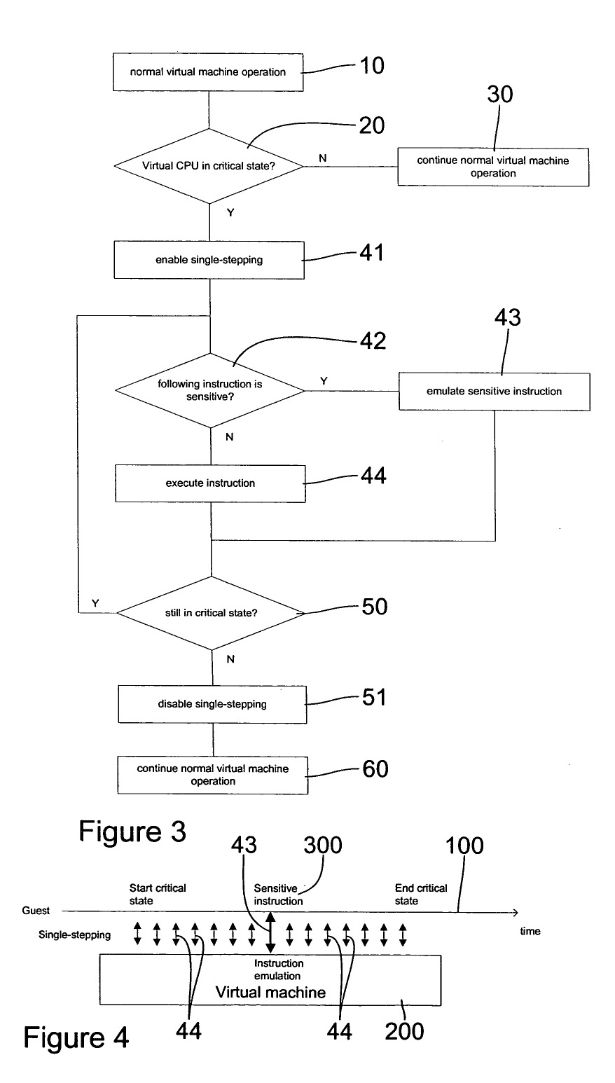

Turning to the embodiment of FIG. 3 the process again starts with the normal virtual machine operation in step 10 and the checking of the state of the virtual central processing means to be critical or not in branch step 20. In case the state is not critical the process continues with normal virtual machine operation in step 30 and—as explained in connection with FIG. 1—back to step 10.

In case that branch step 20 detects that the virtual CPU state is critical e.g. PSR.ic disabled in step 41—single-stepping mode is enabled. In this single-stepping mode there is a step 42 of checking whether or not the following instruction in the guest code sequence is sensitive. If yes—branch Y after step 42—the following sensitive instruction is emulated by the virtual machine in step 43.

If the following instruction is found to be non-sensitive in step 42 this instruction is executed directly in step 44.

From both steps 43 and 44 the process runs to the checking step 50 whether or not the virtual CPU is still in a critical state. If yes—branch Y after step 50—the process goes back to step 42 checking the following instruction to be sensitive or not.

If the critical state of the virtual CPU is terminated—branch N after step 50—the single-stepping mode is disabled in step 51 and normal virtual machine operation is continued in step 60.

The time diagram of FIG. 4 again illustrates the chronological course of the process shown in FIG. 3. With the start of the critical state single-stepping mode is enabled and each following instruction which is not sensitive is directly executed. This is illustrated by the short double-headed arrows representing step 44 of FIG. 3. As soon as a following instruction is detected as to be sensitive in step 42 of FIG. 3 this sensitive instruction 300 is emulated on the virtual machine 200 what is represented by the longer double-headed arrow in FIG. 4 reflecting step 43 of FIG. 3.

All further instructions until the end of the critical state are again non-sensitive and thus directly executed illustrated by shorter double-headed arrows 44 in FIG. 4.

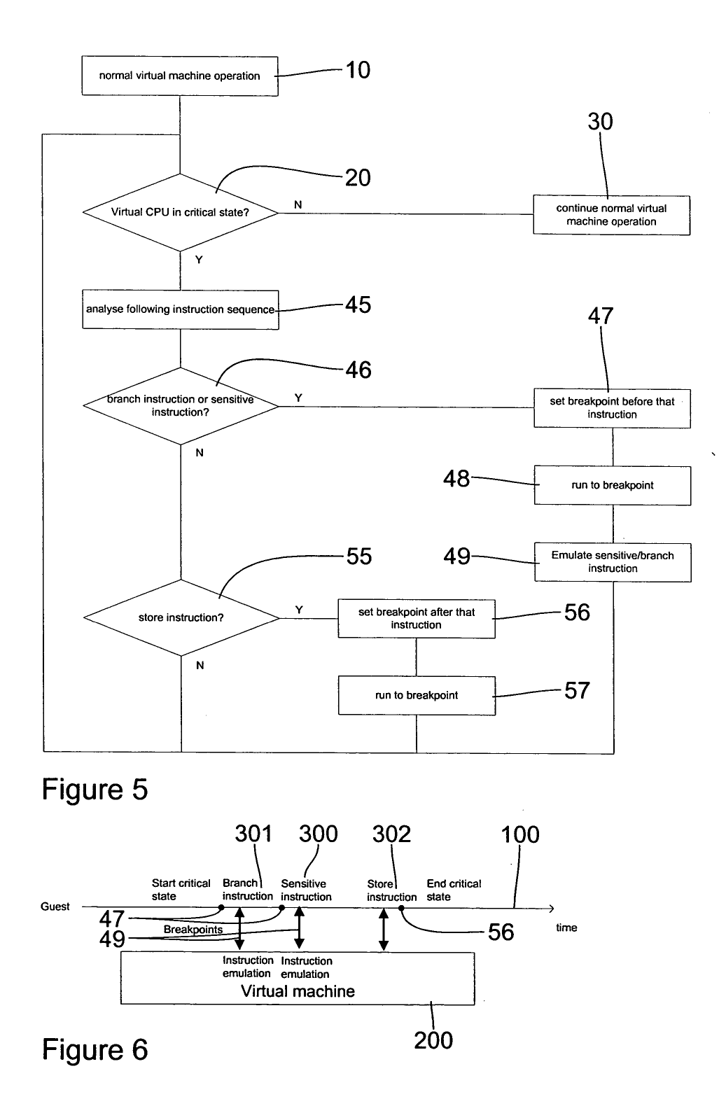

Another preferred embodiment of the method for detecting and processing sensitive non-privileged processor instructions in a virtual machine is depicted in FIG. 5. As concerns step 10 of normal virtual machine operation, step 20 of checking the state of the virtual CPU and step 30 of continuing normal virtual machine operation in case of a non-critical state of the virtual CPU attention is drawn to the according description of FIGS. 1 and 3. Different to these processes, however, is the handling of a guest process in case the virtual CPU is in a critical state (branch Y after step 20 of FIG. 5). In this case the following instruction sequence is analyzed by step 45 by checking whether or not each following instruction is a branch instruction or a sensitive instruction (step 46). If one of these conditions applies—branch Y after step 46—a breakpoint is set before that instruction in step 47. Afterwards the instruction sequence analyzed and terminated by a breakpoint by steps 45 through 47 is directly processed and runs to this breakpoint (step 48). Then the following sensitive or branch instruction is emulated by the virtual machine in step 49 and the process returns to step 20, i.e. normal virtual machine operation with checking whether or not the virtual CPU is in a critical state.

As a bypass of the steps 47 through 49 in case that step 46 returns the result that the analyzed instruction is no branch or sensitive instruction—branch N after step 46—another analyzing step 55 follows which checks whether or not the analyzed instruction is a store instruction. If yes—branch Y after step 55—, a breakpoint is set after that instruction in step 56 and the instruction sequence is executed directly by running the process to this breakpoint (step 57). Afterwards the process returns to normal virtual machine operation and step 20.

The chronological representation of FIG. 6 shows the guest process by time bar 100 changing to the critical state and setting breakpoints before the branch instruction 301 and the sensitive instruction 300, respectively. Accordingly, after reaching the breakpoint set by step 47 the branch and sensitive instructions 301, 300, respectively, are emulated in step 49 illustrated by the according double-headed arrows. Also the detected store instruction 302 with the breakpoint 56 set after that instruction is depicted.

As an advantage of all three processes according to the invention presented above the invention provides for a total specification conforming emulation of sensitive, non-privileged instructions like the cover instruction. Inasmuch there is no dependence on the guest operating system so the virtual machine is capable of running all current operating system versions the same as future versions. Furtheron there is no static/dynamic modification of the guest operating system kernel necessary. Inasmuch the necessity to dynamically re-write portions of the guest operating system is avoided by the invention. Furtheron no special drivers are required for the guest operating systems as the hardware is reproduced as already supported standard hardware components Finally the performance loss by the routines for checking the state of the virtual CPU and analyzing the code is estimated to range from 3% up to 15% which is considerably better than a degradation of up to 30 to 50% of the prior art which deals with non-fully virtualizable processors like the Intel® x 86 (IA-32) and Intel® Itanium® family.

What is claimed is:

1. A method for detecting and processing sensitive non-privileged processor instructions in a virtual machine computer system running computer guest system processes in a virtualized manner on a central processing means, comprising:
switching between two virtual machine operation modes wherein a first mode is a classic mode, in which only privileged instructions are intercepted, and a second mode is a restricted operation mode, and
using the restricted mode being used according to a specific critical state of the virtualized processor, wherein in the restricted mode sensitive non-privileged instructions are detected.

2. A method according to claim 1, wherein the restricted mode uses emulation of instructions including the emulation of sensitive instructions.

3. A method according to claim 2, comprising following method steps:
A) checking the state of the virtual central processing means to be critical or not,
B1) in case the state is not critical continuing normal virtual machine operation,
B2) in case the state is critical emulating the instruction,
C) checking the state of the virtual processing means to be still critical or not,
D1) in case the state is still critical returning to one of step A) and B2),
D2) in case the state is not critical continuing normal virtual machine operation with step A).

4. A method according to claim 1, wherein the restricted mode uses single stepping to intercept before the execution of each instruction to allow the detection and emulation of sensitive non-privileged instructions.

5. A method according to claim 4, comprising following method steps:
A) checking the state of the virtual central processing means to be critical or not,
B1) in case the state is not critical continuing normal virtual machine operation,
B2) in case the state is critical
B2.1) enabling single stepping mode and
B2.2) checking whether or not a following instruction is sensitive,
B2.3.1) in case the following instruction is sensitive emulating said instruction, or
B2.3.2) in case the following instruction is not sensitive executing the instruction,
C) checking the state of the virtual processing means to be still critical or not,
D1) in case the state is still critical return to step B2.2),
D2) in case the state is not critical any more disabling single stepping mode and
E) continuing normal virtual machine operation with step A).

6. A method according to claim 1, wherein the restricted mode analyzes code sequences and uses instruction breakpoints to intercept after execution of that code sequence.

7. A method according to claim 6 where the sequence is analyzed for the occurrence of sensitive non-privileged instructions and branch instructions.

8. A method according to claim 7, comprising following method steps:
A) checking the state of the virtual central processing means to be critical or not,
B1) in case the state is not critical continuing normal virtual machine operation,
B2) in case the state is critical analysing each following instruction of an instruction sequence whether or not the instruction is one of a branch instruction or sensitive instruction,
B3.1) in case that no branch instruction or sensitive instruction is detected continuing normal machine operation,
B3.2.1) in case that one of the branch instruction or sensitive instruction is detected setting a break point in front of said instruction,
B3.2.2) executing the instructions up to the breakpoint,
B3.2.3) starting next sequence at a target of said branch instruction or emulating said sensitive instruction, and
C) continuing normal machine operation with step A).

9. A method according to claim 8, wherein store instructions are detected as well.

10. A method according to claim 9, wherein successful taken branch instructions are detected using a “taken branch” trap.

11. A method according to claim 1, comprising the step of checking whether or not the virtual central processing means is in one of the interrupt enabled state or the interrupt disabled state, the interrupt disabled state being the critical state.

12. A method according to claim 1, wherein the instruction is checked to be a sensitive, non-privileged “cover stack frame” instruction.
